(19) United States
(12) Patent Application Publication
(10) Pub. No.: US 2006/0274044 A1
(43) Pub. Date: Dec. 7, 2006

(54) WHOLE HAND COMPUTER MOUSE WITH A BUTTON FOR EACH FINGER

(76) Inventor: David Cameron Gikandi, Broadbeach (AU)

Correspondence Address: DAVID CAMERON GIKANDI, 15 ALBERT AVENUE, SUITE 292, BROADBEACH, 4218, AU

(21) Appl. No.: 11/308,012

(22) Filed: Mar. 3, 2006

Related U.S. Application Data
(60) Provisional application No. 60/679,765, filed on May 11, 2005.

(51) Int. Cl. G09G 5/08

(52) U.S. Cl. 345/163

(57) ABSTRACT

A whole-hand computer mouse that has one button for each finger of the hand. Each finger can press its own button that, in itself or in combination with other pressed buttons or hand movements (gestures), executes a computer command such as cutting, pasting, opening a new document, scrolling, copying and so on. This is in addition to the common functions of computer mice, namely moving the cursor on the screen, selecting items and opening context-sensitive pop-up menus. An object of this invention is to improve efficiency, productivity and performance on Windows and other operating systems and programs by simplifying, speeding and extending the functions performed by computer mice so that the mouse takes over, in efficient and user-friendly ways, functions that would otherwise have to be performed through the keyboard or menu items. Still further objects and advantages will become apparent from a consideration of the ensuing descriptions and drawings.

### RELATED APPLICATIONS

The present application is a continuation-in-part application of U.S. provisional patent application Ser. No. 60/679,765, filed May 11, 2005, for WHOLE HAND COMPUTER MOUSE WITH A BUTTON FOR EACH FINGER, by David Cameron Gikandi, included by reference herein and for which benefit of the priority date is hereby claimed.

### FIELD OF THE INVENTION

The present invention relates to computer mouse devices (computer input devices, pointing devices) and more particularly pertains to a new, whole hand computer mouse device with a button for each of the five fingers of the hand, for controlling a cursor displayed on a personal computer, executing common software commands and other custom and pre-programmed commands, and increasing work efficiency by eliminating the need to use keyboard and software menus.

### BACKGROUND OF THE INVENTION

Ever since computers were invented, there has been a need to simplify their use to accomplish more in less time and allow a wider audience to use them. There has been a need to reduce the learning curve. Moreover, there has been a need to increase efficiency and productivity. The ability to use a computer to accomplish tasks faster and in simpler ways was desired by workers and other users since the very first computer was invented.

Because of increased stress and an ever-demanding workload, workers are increasingly forced to produce work and output within ever-tightening deadlines. Therefore, the need to reduce the time it takes to accomplish particular tasks on a computer is clear. The fewer steps a person needs to take to accomplish a particular computer task the better.

Almost all computer users use a mouse to work with a computer. Therefore, one way to increase efficiency when using a computer is to focus on increasing efficiency at the mouse level.

All previous mouse inventions have followed a common concept that assigns the primary operation of a mouse to the index and middle fingers operating the left and right mouse buttons respectively (that is for right-handed people; it is opposite for left-handed people). Sometimes, a mouse may have a third middle button, or other special function buttons such as a button to launch the browser. However, the prior mouse inventions have approached the mouse design from the idea of a two-fingered approach. This new invention described here is the first to make a whole-hand mouse that allows the user to operate the mouse with the whole hand. Each finger on the hand is given its own button, and the user operates the mouse in a way that is similar to how he or she uses the hands and fingers in real life.

The main problem with previous mouse inventions is that a user still has to use keyboard shortcuts and menu commands to execute commands such as saving a document or copying and pasting. The previous mice cannot execute many of these commands on their own without having to make the user utilize the keyboard shortcuts and menus. Having to use menu commands and keyboard shortcuts takes time. Eliminating the need for these shortens the time it takes to execute a command or function such as saving a document or copying and pasting and thus increases efficiency.

Prior art includes U.S. Pat. Nos. 5,530,455, 5,880,715, 5,157,381, 6,377,254, 5,894,303, 6,492,975, 6,690,359, and 350,737.

The shortcomings of other solutions is that a user has to use the menu commands or keyboard shortcuts to execute commands and functions such as copying and pasting, saving documents, creating new documents, browsing and scrolling, and other such tasks. The biggest disadvantage of previous computer mice inventions is that they don't take advantage of the whole hand, nor the movements of the hand for initiating document and window commands other than moving the mouse pointer around, nor all the fingers of the hand by giving each their own mouse button. They mostly make use of the index and middle fingers of the hand only and restrict hand movements to controlling the movement of the mouse pointer on the screen.

Because of the above-mentioned disadvantage, they necessitate the use of a program's menu command and keyboard much more than would be necessary with this new invention. This new whole hand computer mouse invention therefore cuts down on the amount of time it takes to accomplish common computing tasks, increasing efficiency and productivity.

No computer mouse formerly developed provides a button for each finger of the hand, and have those buttons configurable in ways in which various button click combinations and hand movement combinations result in the execution of tasks such as cut, copy, paste, start a new document, delete, and so on. All other previously invented computer mouse devices heavily rely a primarily two-button operation (left-click or right-click) and on keyboard or menu items to execute such functions as cut, copy, paste, move, new document, delete, and so on.

By having a button for each finger of the hand and pre-programming functionality for each of those buttons, combination of buttons, and gestures (pre-defined hand movements such as tracing an S-shape while holding down the little finger button so as to execute a document save command), this new mouse invention eliminates the need for a user to have to use keyboard shortcuts or menu commands.

Having to use menu commands and keyboard shortcuts takes time. Eliminating the need for these shortens the time it takes to execute a command or function such as saving a document or copying and pasting and thus increases efficiency.

It is therefore an object of the invention to improve efficiency, productivity and performance on Windows and other operating systems and programs by simplifying, speeding and extending the functions performed by computer mice so that the mouse takes over, in efficient and user-friendly ways, functions that would otherwise have to be performed through the keyboard or menu items. This is achieved by clicking one or more of the mouse buttons, and sometimes with the addition of mouse gestures (such as moving the mouse in an ‘N’ shape while holding onto the little finger button to open a new document).

It is another object of the invention to speed up computer use by eliminating the need to use the keyboard or software menus to effect common computing tasks such as saving a document, deleting, cutting, pasting, opening new documents, browsing, and so on. This invention proposes a new, simpler and faster way to accomplish common computing tasks such as cut and paste, save, and so on.

It is another object of the invention to provide a mouse that gives the user a wide variety of extra functions accessible by simple combinations of mouse clicks and hand movements.

It is another object of the invention to provide a mouse that takes full advantage of all five fingers of a person's hand.

It is another object of the invention to provide a mouse whose user's hand and wrist are accommodated by a naturally curving and relaxed position that accommodates the whole hand and reduces fatigue, discomfort, injury and pain.

It is another object of the invention to provide a mouse whose user's fingers can easily handle and click the buttons.

It is another object of the invention to provide a mouse that is easy to move about and provides a good grip.

It is another object of the invention to allow various functions to be programmed into the buttons on the mouse to allow users of a wide variety of software programs to customize the mouse's functionality to suit their particular needs.

It is another object of the invention to enable users to change the mouse housing/casing using artistically designed, third-party snap-on covers.

Still further objects and advantages will become apparent from a consideration of the ensuing descriptions and drawings.

### SUMMARY OF THE INVENTION

In accordance with the present invention, there is provided a whole-hand computer mouse that has one button for each finger of the hand. Each finger can press its own button that, in itself or in combination with other pressed buttons or hand movements, executes a computer command or function such as cutting, pasting, opening a new document, scrolling, copying and so on. This is in addition to the common functions of computer mice, namely moving the cursor on the screen, selecting items and opening context-sensitive pop-up menus.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top plan view of a computer mouse constructed in accordance with the invention. This illustrates the concept discussed in this invention;

FIG. 2 is a front perspective view of a mouse constructed in an alternative embodiment;

FIG. 3 is a left perspective view of a mouse in FIG. 2;

FIG. 4 is a right perspective view of a mouse in FIG. 2;

FIG. 5 is a left perspective view of a mouse constructed in an alternative embodiment that features a wrist-rest;

FIG. 6 is a right perspective view of a mouse FIG. 5; FIG. 7 is a rear perspective view of a mouse FIG. 5;

FIG. 8 is a front perspective view of a mouse FIG. 5;

FIG. 9 is a top perspective view of a mouse constructed in an alternative embodiment;

FIG. 10 is a front-left perspective view of a mouse FIG. 9;

FIG. 11 is a front perspective view of a mouse FIG. 9;

FIG. 12 is a left perspective view of a mouse FIG. 9;

FIG. 13 is a top-back-right perspective view of a mouse constructed in an alternative embodiment;

FIG. 14 is a top-back-left perspective view of a mouse FIG. 13; and

FIG. 15 is a top-front-right perspective view of a mouse FIG. 13.

For purposes of clarity and brevity, like elements and components will bear the same designations and numbering throughout the Figures.

### DESCRIPTION OF THE PREFERRED EMBODIMENT

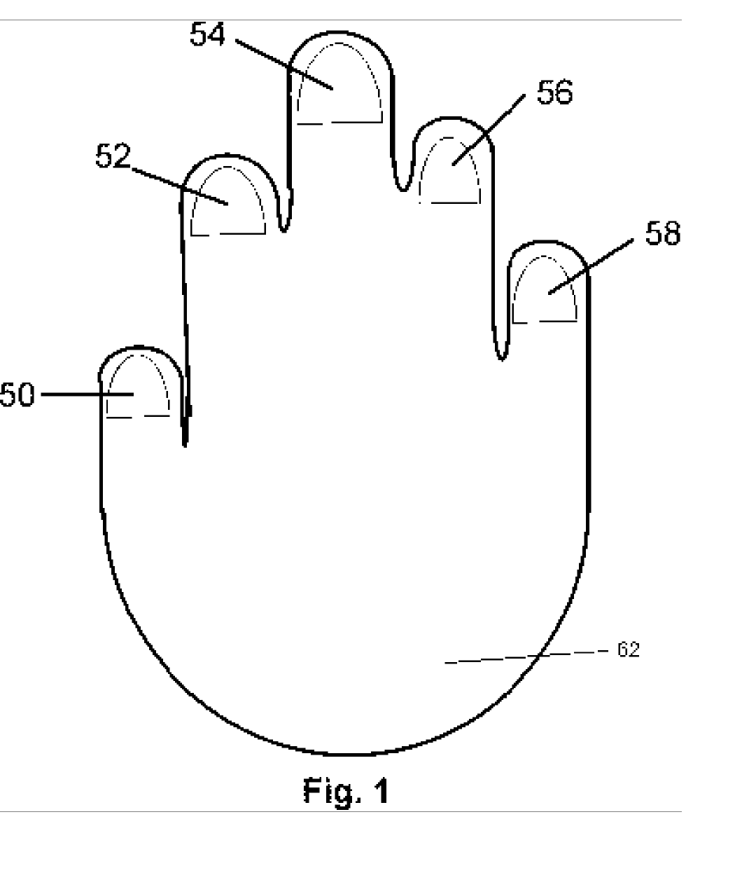

FIG. 1 is a top plan view of a computer mouse constructed in accordance with the invention. This illustrates the concept discussed in this invention. The user's thumb rests and clicks on the Thumb Finger Button 50. The index finger rests and clicks on the Index Finger Button 52. The middle finger rests and clicks on the Middle Finger Button 54. The ring finger rests and clicks on the Ring Finger Button 56. And the little finger rests and clicks on the Little Finger Button 58. The user's hand rests on the Body 62 and uses the Body 62 to hold onto the mouse and move it around. The user can click on any one of the buttons or on a combination of them. The buttons are mounted on the Body 62 in the same way as they are mounted on other mouse inventions; specifically, they can be pressed on and when released, they bounce back to their original position, hence providing the ability to click. In this embodiment, the mouse Body 62 resembles the human hand and the user simply places his or her open palm on the Body 62.

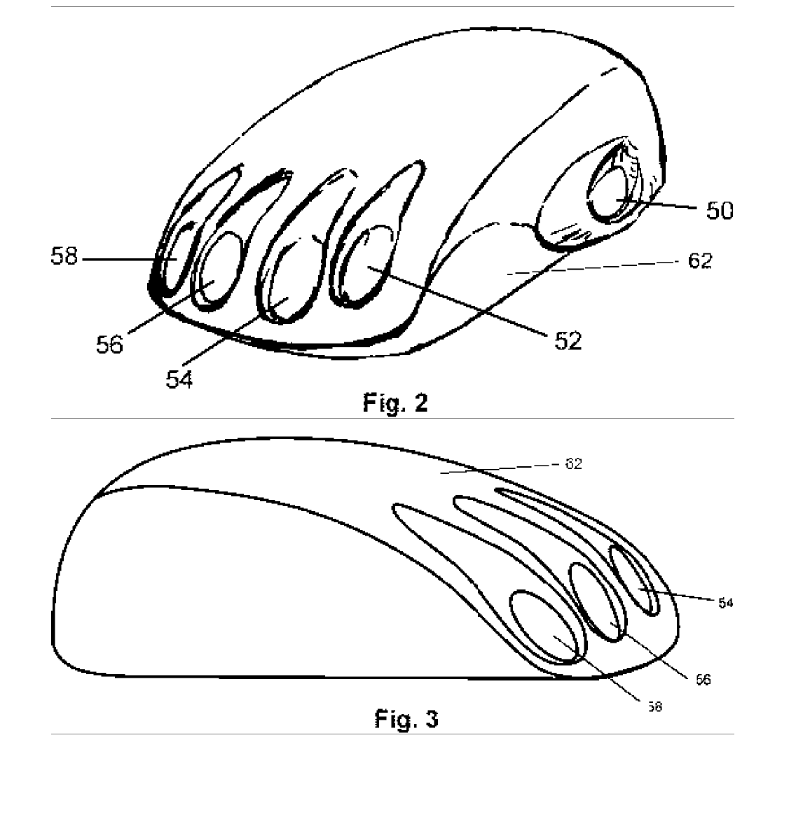

FIG. 2 is a front perspective view of a mouse constructed in an alternative embodiment. In this embodiment, the Body 62 is constructed so that the user's hand grips it like it would grip and object being picked up.

FIG. 3 is a left perspective view of a mouse in FIG. 2.

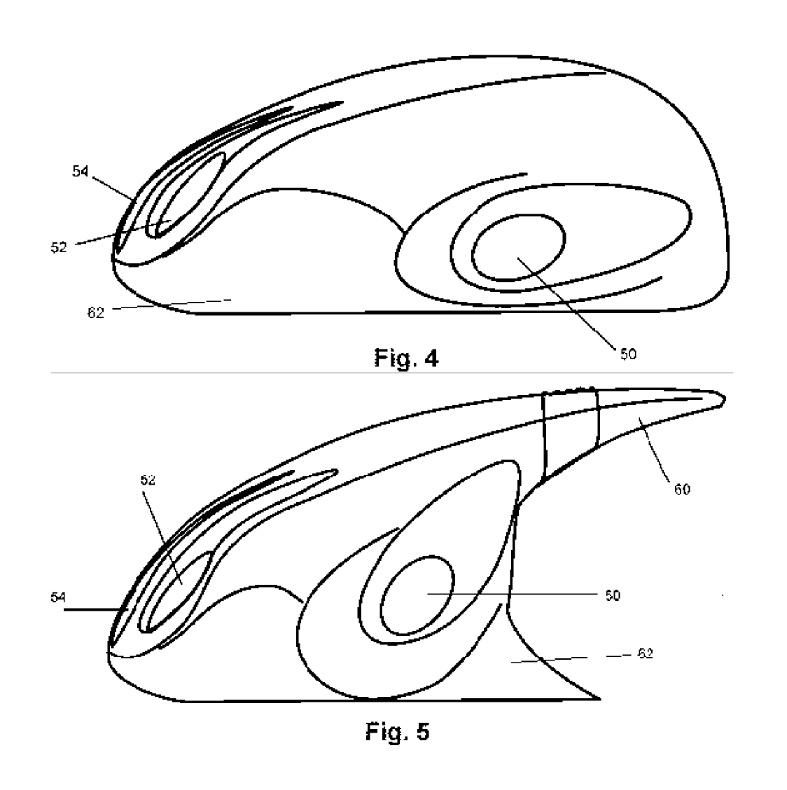

FIG. 4 is a right perspective view of a mouse in FIG. 2.

FIG. 5 is a left perspective view of a mouse constructed in an alternative embodiment that features a Wrist Rest 60 that is for supporting the wrist so that the user is comfortable holding the mouse and moving it around without straining the rest of the arm.

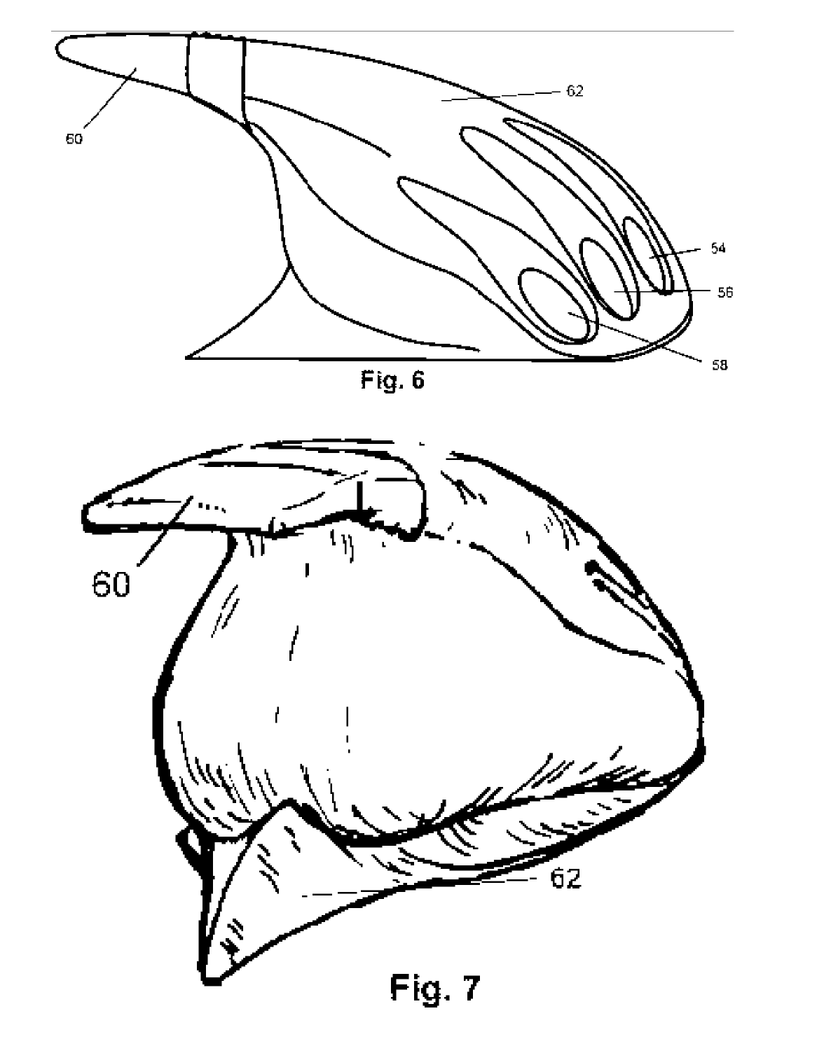

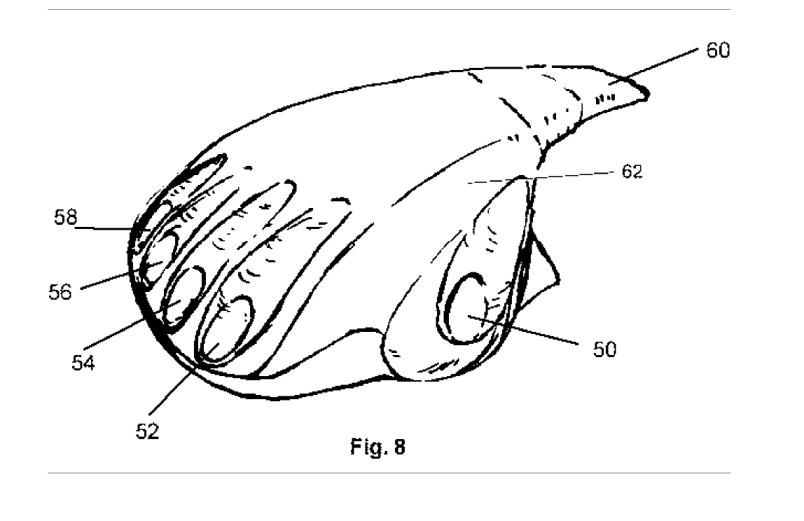

FIG. 6 is a right perspective view of a mouse FIG. 5.

FIG. 7 is a rear perspective view of a mouse FIG. 5.

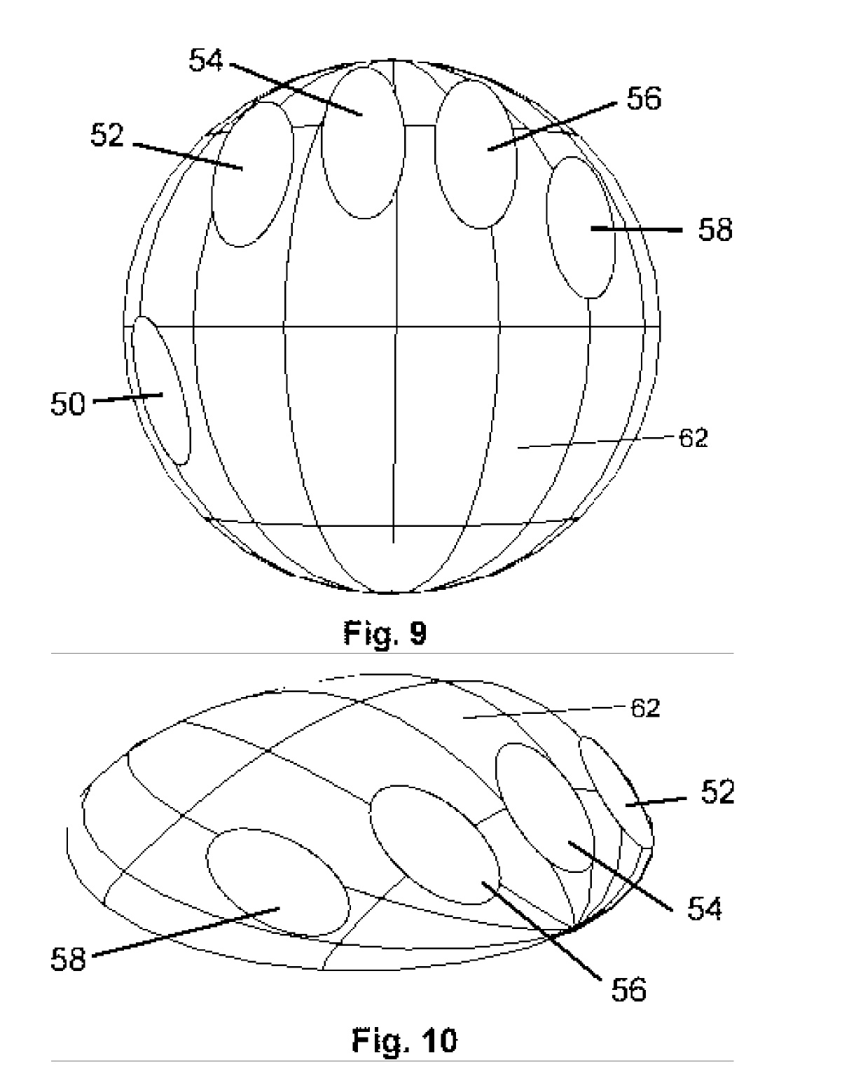

FIG. 9 is a top perspective view of a mouse constructed in an alternative embodiment whereby the Body 62 is very much like a half-sphere.

FIG. 10 is a front-left perspective view of a mouse FIG. 9.

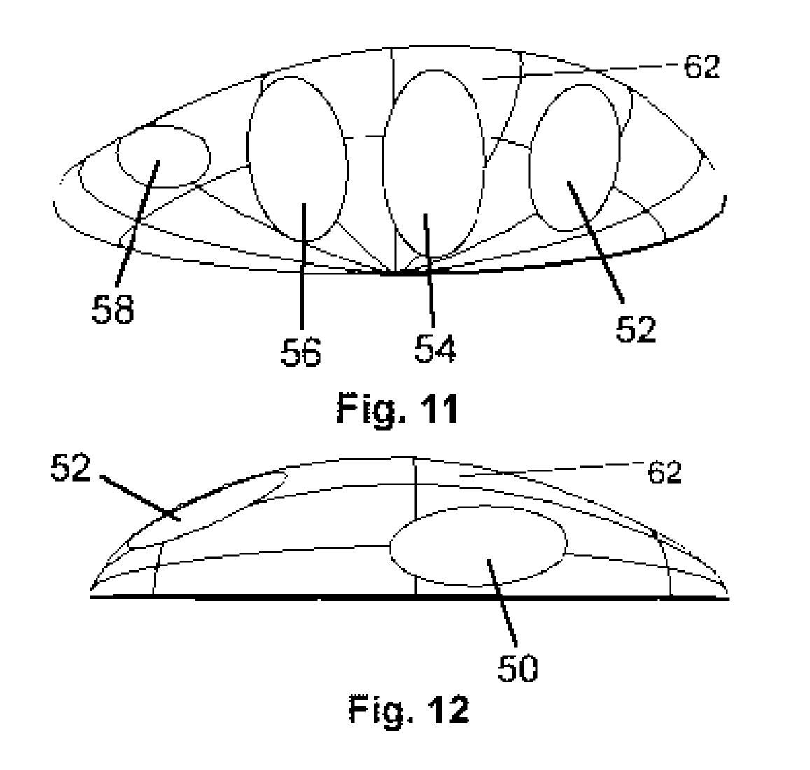

FIG. 11 is a front perspective view of a mouse FIG. 9.

FIG. 12 is a left perspective view of a mouse FIG. 9.

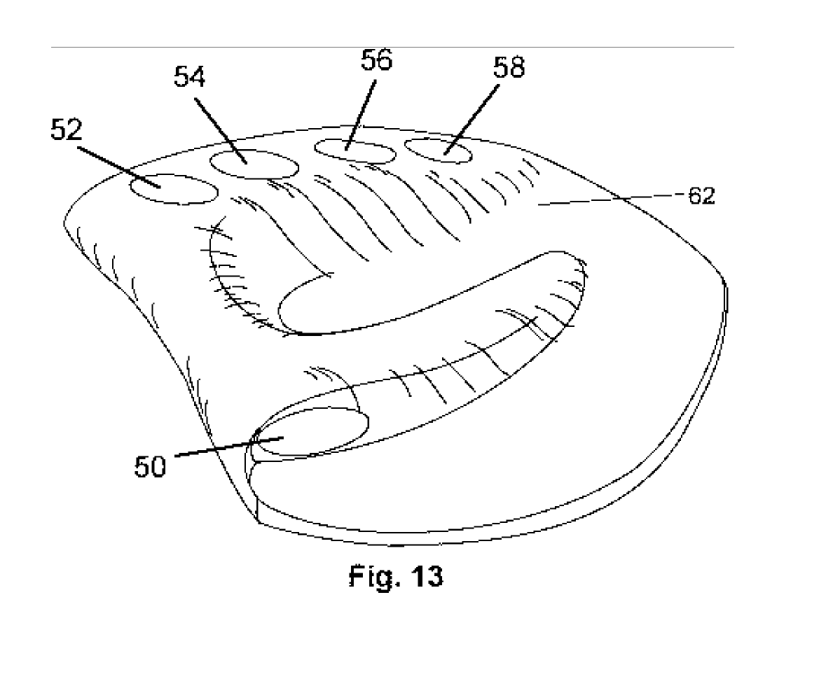

FIG. 13 is a top-back-right perspective view of a mouse constructed in an alternative embodiment. Here, the Body 62 is built with grooves and raised parts inversely corresponding to the grooves and raised parts of a user's hand to provide a relaxed, ergonomic surface.

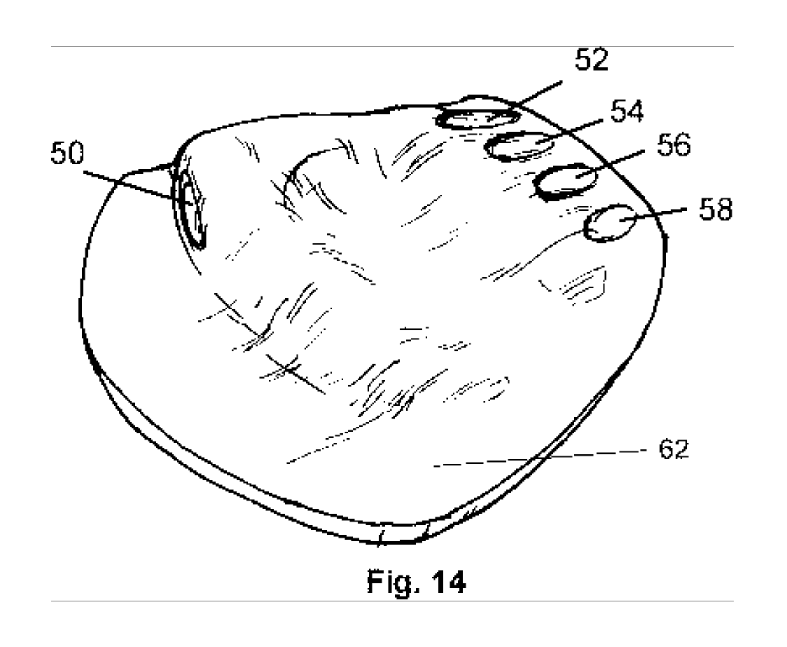

FIG. 14 is a top-back-left perspective view of a mouse FIG. 13.

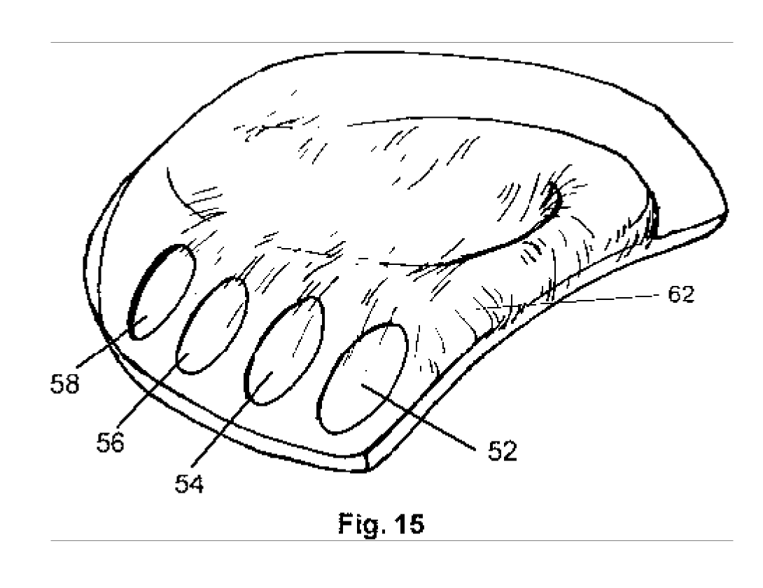

FIG. 15 is a top-front-right perspective view of a mouse FIG. 13.

In Operation:

In operation, a person can use the mouse in the usual manner just like with previous mouse inventions. The Index Finger Button 52 still works as the left-click mouse button as is common with previous mouse inventions, while the Middle Finger Button 54 still works as the right-click mouse button as is common with previous mouse inventions.

Additional tasks, other than the usual left-click and right-click ones associated with previous mouse designs, are accomplished by clicking one or more of the five buttons. The buttons come with default behaviors programmed into them but they can be custom programmed to work differently with each application or operating system that the user uses.

For example, to achieve a cut and paste in a Microsoft Word document, the user may do the following:

(1) Take the mouse pointer to the beginning of where they wish to start selecting the text to cut.

(2) Click and hold down on the Index Finger Button 52 (the usual left-click finger on all mice).

(3) Move the mouse pointer to where they wish to finish selecting the text to cut and let go of the Index Finger Button 52. This, as with all other mice, will highlight the text.

(4) Now, the user would click and hold on the Thumb Finger Button 50 (this will activate the preprogrammed Cut function and thus cause the selected text to be cut), move the mouse pointer to the location of where they wish to paste the selected text, and let go of the Thumb Finger Button 50 (this will activate the preprogrammed Paste function and thus cause the cut text to be pasted here).

(5) If the user simply wished to cut the text without pasting it (delete it), they would simply click on the Thumb Finger Button 50 without holding it (this will activate the preprogrammed Delete function and thus would delete the selected text).

As another example, to achieve a copy and paste in a Microsoft Word document, the user may do the following:
(1) Take the mouse pointer to the beginning of where they wish to start selecting the text to cut.
(2) Click and hold down on the Index Finger Button 52 (the usual left-click finger on all mice).
(3) Move the mouse pointer to where they wish to finish selecting the text to cut and let go of the Index Finger Button 52. This, as with all other mice, will highlight the text.
(4) Now, the user would click and hold on the Ring Finger Button 56 (this will cause the selected text to be copied), move the mouse pointer to the location of where they wish to paste the selected text, and let go of the Ring Finger Button 56 (this will cause the copied text to be pasted here).
(5) If the user simply wished to copy the text without pasting it, they would simply click on the Ring Finger Button 56 without holding it.

Other possible function examples:

Clicking on the Little Finger Button 58 when nothing is highlighted may launch a pop-up menu with a list of the eight last opened documents so that the user may then select one with the usual Index Finger Button 52 click.

Clicking on the Ring Finger Button 56 when nothing is highlighted may launch a pop-up menu with a list of the eight last used applications so that the user may then select one with the usual Index Finger Button 52 click.

Double-clicking on the Thumb Finger Button 50 may cause the last performed action to be undone.

Double-clicking on the Little Finger Button 58 may cause the last undone action to be redone.

Clicking and holding down on the Little Finger Button 58 and tracing an ‘N’ shape with the mouse may open a new document in the application, tracing an ‘O’ shape may open a new document, while tracing an ‘S’ shape may save the document being worked on.

Clicking and holding down on the Ring Finger Button 56 and moving the mouse down may scroll the document down, or moving it left to scroll left, or any other direction to scroll in that direction.

There are many other possible ways to program the five buttons so that they may function in various useful ways. This mouse can be programmed to work in the best possible ways as deemed by its users in various applications such as word processing, spreadsheets, databases, graphics, computer aided design (CAD), modeling, browsing, gaming, and so on. Although the mouse would ship with default functionality, the software interface between the mouse and the operating system or applications is open for any third party to modify, thus giving developers and end-users the freedom to make each button perform whatever tasks they wish.

Although the description above contains many specifics, these should not be construed as limiting the scope of this invention but as merely providing illustrations of some of the preferred or possible embodiments of this invention. For example:

The mouse can have other Body 62 shapes such as circular, oval, triangular, etc.

The mouse can be constructed of plastic, rubber, or any other suitable materials.

The mouse detailed here is for desktop computers (or external laptop mouse use), but design modifications can be made to make the mouse fit into a laptop or handheld computer either as part of the main housing of these devices or as an external device.

The mouse can be designed for left- or right-handed users.

A scroll wheel can be added to the mouse.

Various scanners can be added to the mouse, such as a thumbprint scanner for security.

The Body 62 can be built to vibrate for the sake of alerting the user when specific computer events are raised.

The Body 62 can be built so that it provides massaging to the user's hand.

The mouse can be optical or wheel based (as the mechanism employed to move the cursor on the screen), and it can use any of various technologies to connect to the computer (such as wireless, cable, or Bluetooth).

The mouse is also intended to come with optional decorative snap-on covers (like mobile phones do) allowing the user to change the top and/or bottom covers of the mouse to a design of their liking.

The mouse can be made with grip-improved materials such as studded rubber, or by adding protrusions between the fingers to increase grip.

Although we focus on five buttons, one for each finger of the hand, the mouse can be built with less or more than these five buttons.

The mouse can also be ergonomically designed to achieve various health and comfort ends.

It can also be built to be adjustable for various hand sizes.

It can also be built as a glove.

It can be wireless, use Bluetooth, infrared or any other methodology or technology capable of achieving said ends.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A whole hand computer mouse with a button for each finger for increasing the efficiency of computer users by eliminating the need for them to use application and operating system keyboard shortcuts and menu commands to execute functions and software commands, comprising:
means for executing the cut/paste command or any other pre-programmed command or function in a software application or operating system;
means for executing the select command or any other pre-programmed command or function in a software application or operating system;
means for executing the popping up of a context menu or any other pre-programmed command or function in a software application or operating system;
means for executing the popping up of a menu with a list of the eight last used applications or executing any other pre-programmed command or function in a software application or operating system; and
means for executing the popping up of a menu with a list of the eight last opened documents or executing any other pre-programmed command or function in a software.

2. The whole hand computer mouse with a button for each finger in accordance with claim 1, wherein said means for executing the cut/paste command or any other pre-programmed command or function in a software application or operating system comprises a clickable thumb finger button.

3. The whole hand computer mouse with a button for each finger in accordance with claim 1, wherein said means for executing the select command or any other pre-programmed command or function in a software application or operating system comprises a clickable index finger button.

4. The whole hand computer mouse with a button for each finger in accordance with claim 1, wherein said means for executing the popping up of a context menu or any other pre-programmed command or function in a software application or operating system comprises a clickable middle finger button.

5. The whole hand computer mouse with a button for each finger in accordance with claim 1, wherein said means for executing the popping up of a menu with a list of the eight last used applications or executing any other pre-programmed command or function in a software application or operating system comprises a clickable ring finger button.

6. The whole hand computer mouse with a button for each finger in accordance with claim 1, wherein said means for executing the popping up of a menu with a list of the eight last opened documents or executing any other pre-programmed command or function in a software application or operating system comprises a clickable little finger button.
